(19) United States
(12) Patent Application Publication
(10) Pub. No.: US 2025/0251561 A1
(43) Pub. Date: Aug. 7, 2025

(54) OPTICAL FIBER MANAGEMENT TRAY FOR ROLLABLE FIBER RIBBONS

(71) Applicant: CommScope Technologies LLC, Hickory, NC (US)

(72) Inventors: Geert PARTON, Lubbeek (BE); David VAN BAELEN, Winksele (BE); Wouter VRANKEN, Testelt (BE); Heidi BLEUS, Genk (BE)

(73) Assignee: CommScope Technologies LLC, Hickory, NC (US)

(21) Appl. No.: 18/855,413

(22) PCT Filed: Apr. 12, 2023
(86) PCT No.: PCT/US2023/018337

§ 371 Date: Oct. 9, 2024

Related U.S. Application Data
(60) Provisional application No. 63/331,273, filed on Apr. 15, 2022.

(51) Int. Cl. G02B 6/44

(52) U.S. Cl. CPC G02B 6/4454; G02B 6/44528; G02B 6/4455

(57) ABSTRACT

Optical fiber management tray with optimized dimensions and/or features for managing optical fiber ribbons at a rack mountable and slidable distribution tray of telecommunications equipment.

### CROSS-REFERENCE TO RELATED APPLICATION

This application is being filed on Apr. 12, 2023, as a PCT International application and claims the benefit of and priority to U.S. Provisional Application No. 63/331,273, filed Apr. 15, 2022, the disclosure of which is hereby incorporated by reference in its entirety.

### TECHNICAL FIELD

The present invention relates to telecommunications distribution systems, e.g., optical fiber distribution systems, which may include a rack and elements which populate the rack, such as optical fiber management trays for management of rollable fiber ribbons.

### BACKGROUND

Optical fiber distribution systems may include fiber terminations and other equipment which is typically rack mounted. Various concerns exist for the optical fiber distribution systems, including density, ease of use and mounting, and cable management. There is a continuing need for improvements in the telecommunications distribution area, especially optical fiber distribution.

### SUMMARY

In general terms, the present disclosure is directed to improvements in optical fiber management trays of optical fiber distribution systems.

The fibers managed in optical fiber distribution systems can come in different forms, such as loose fibers or ribbonized fibers. Groups of loose fibers, e.g., groups of 12 loose fibers, or axial portions thereof, can be housed in protective tubes. Ribbonized fibers (or a fiber ribbon) include a plurality of fibers, e.g., 12 fibers, bonded together. The fibers of the ribbon can be bonded side by side along their axial lengths to form a flat ribbon, or bonded at intervals along their axial lengths to form a rollable ribbon of fibers or a rollable fiber ribbon. Example rollable fiber ribbons include the AccuRiser™ and AccuFlex@rollable ribbon cables by OFS Fitel, LLC, Norcross, Georgia, U.S.A.

Rollable fiber ribbons include bonded sections of the fibers interspersed by longitudinal non-bonded sections. Rollable fiber ribbons can include any suitable number of fibers, such as 4, 6, 8, 10, 12 fibers, or more. Due to the non-bonded sections, there is a tendency for individual ones of the fibers in the non-bonded sections to depart or stray from the path or desired path of the overall rollable ribbon, particularly when the path includes curves, which can cause signal transmission reduction, signal loss, and/or fiber breakage.

Depending on specific network requirements at a given optical fiber distribution system, it may be desirable to route fiber ribbons, loose fibers or both. A typical fiber management tray of a slidable distribution tray of an optical fiber distribution rack is configured to manage individual loose fibers, and is not configured to efficiently manage rollable fiber ribbons.

In an aspect, the present disclosure is directed to a slidable distribution tray of an optical fiber distribution rack that is configured to support management of rollable fiber ribbons.

In another aspect, the present disclosure is directed to a fiber management tray that can be pivotally mounted to a slidable distribution tray of an optical fiber distribution rack, the fiber management tray being configured to support management of rollable fiber ribbons.

In another aspect, the present disclosure is directed to a slidable distribution tray of an optical fiber distribution rack with pivotally mounted optical fiber management trays configured to support management of rollable fiber ribbons.

According to certain specific aspects of the present disclosure, a fiber management tray for managing rollable fiber ribbons, includes: a tray body extending from a front end of the tray to a back end of the tray along a first axis, the tray extending form a left end of the tray to a right end of the tray along a second axis, the tray extending from a top end of the tray to a bottom end of the tray along a third axis, the first axis, the second axis and the third axis being mutually perpendicular, the tray body including: couplers at the back end of the tray for pivotally coupling the fiber management tray to a slidable distribution tray; and a tray interior volume defined by: a fiber management surface; an outer wall projecting from the fiber management surface parallel to the third axis to define a depth of the interior, the depth extending parallel to the third axis from a top end of the wall to the surface, wherein a ratio of the depth to a maximum length of the surface parallel to the first axis is at least 0.050.

According to further specific aspects of the present disclosure, a fiber management tray for managing rollable fiber ribbons, comprising: a tray body extending from a front end of the tray to a back end of the tray along a first axis, the tray extending form a left end of the tray to a right end of the tray along a second axis, the tray extending from a top end of the tray to a bottom end of the tray along a third axis, the first axis, the second axis and the third axis being mutually perpendicular, the tray body including: couplers at the back end of the tray for pivotally coupling the fiber management tray to a slidable distribution tray; and a tray interior volume defined by: a fiber management surface; and an outer wall projecting from the fiber management surface; wherein the tray body defines opposing entryways by which rollable fiber ribbons can enter the tray interior volume; wherein the outer wall defines a gap in the outer wall adjacent the entryways and extending continuously along a width of the gap from one end of the outer wall to another end of the outer wall parallel to the second axis; and wherein a ratio of the gap width to a maximum width of the surface parallel to the second axis is at least 0.3.

According to further specific aspects of the present disclosure, a fiber management tray for managing rollable fiber ribbons, comprising: a tray body extending from a front end of the tray to a back end of the tray along a first axis, the tray extending form a left end of the tray to a right end of the tray along a second axis, the tray extending from a top end of the tray to a bottom end of the tray along a third axis, the first axis, the second axis and the third axis being mutually perpendicular, the tray body including: couplers at the back end of the tray for pivotally coupling the fiber management tray to a slidable distribution tray; and a tray interior volume defined by: a fiber management surface; and an outer wall projecting from the fiber management surface; wherein the tray body defines within the interior volume a fiber routing region and a fiber management region; wherein the fiber management region includes other walls in addition to the outer wall that define receivers for receiving splice bodies of splices between rollable fiber fibers; and wherein a ratio of a maximum dimension of each of the outer walls to a maximum width of the surface parallel to the second axis is less than 0.7.

A variety of additional aspects will be set forth in the description that follows. The aspects relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not necessarily to scale and are intended for use in conjunction with the explanations in the following detailed description. Embodiments of the present disclosure will hereinafter be described in conjunction with the appended drawings, wherein like numerals denote like elements.

FIG. 1 is a perspective view of a distribution tray assembly according to the present disclosure.

FIG. 2 is a perspective view of the distribution tray of the assembly of FIG. 1.

FIG. 3 is a further perspective view of the distribution tray of FIG. 2.

FIG. 4 is a perspective view of the cover of the assembly of FIG. 1.

FIG. 5 is a further perspective view of the cover of FIG. 4.

FIG. 6 is a perspective view of a portion of the assembly of FIG. 1.

FIG. 7 is a further perspective view of the portion of FIG. 6.

FIG. 8 is a perspective view of the portion of FIG. 6 and showing one of the fiber management trays in a pivoted up configuration.

FIG. 9 is a planar top view of the portion of FIG. 6.

FIG. 10 is a cross-sectional view of the portion of FIG. 6 along the line 10-10 of FIG. 9.

FIG. 11 is a perspective view of one of the fiber management trays of the assembly of FIG. 1.

FIG. 12 is a further perspective view of the fiber management tray of FIG. 11.

FIG. 13 is a further perspective view of the fiber management tray of FIG. 11.

FIG. 14 is a further perspective view of the fiber management tray of FIG. 11.

FIG. 15 is a top, planar view of the fiber management tray of FIG. 11.

FIG. 16 is a bottom, planar view of the fiber management tray of FIG. 11.

FIG. 17 is a planar, back end view of the fiber management tray of FIG. 11.

FIG. 18 is a planar, front end view of the fiber management tray of FIG. 11.

FIG. 19 is a planar, side view of the fiber management tray of FIG. 11.

FIG. 20 is a further planar, side view of the fiber management tray of FIG. 11.

FIG. 21 is a perspective, enlarged view of a portion of the fiber management tray of FIG. 11.

FIG. 22 is further perspective, enlarged view of the portion of the fiber management tray of FIG. 21.

FIG. 23 is a perspective view of a distribution tray assembly according to the present disclosure, and including routed rollable fiber ribbons.

FIG. 24 is a perspective view of a management tray for individual fibers.

FIG. 25 is a further perspective view of the tray of FIG. 23.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

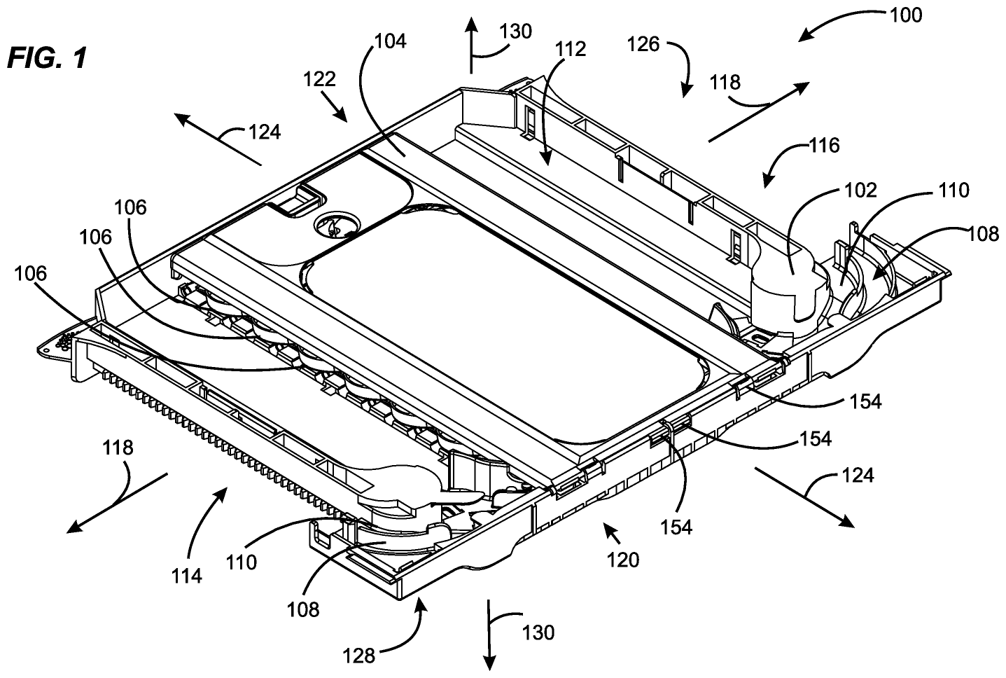

Referring to FIG. 1, a distribution tray assembly 100 according to the present disclosure includes a distribution tray 102 and a cover 104 that covers, and thereby protects, fiber management trays 106 that are pivotally mounted to the distribution tray 102. By abutting the trays 104, the cover 104 can also keep the trays 106 secured in their pivoted down configurations. Optical fibers enter the distribution tray 102 via opposing entry passages and exit passages 108, 110. Once in the interior tray volume 112 of the distribution tray 102, the optical fibers can be routed onto fiber management trays 106. The fiber management trays 106 can support optical fiber splices, optical fiber splitter modules, wave division multiplexers, adapters and connectors terminating optical fibers that are received in the adapters to establish optical connection between the connectorized fibers, and/or other fiber management components. The fiber management trays 106 are pivotally mounted to the distribution tray 102 and positioned within the interior tray volume 112. In FIG. 1, all of the fiber management trays 106 are in a pivoted down position. A fiber management tray 106 can be pivoted up to provide access to the fiber management area of another of the trays 106. In this manner, the fiber management trays 106 can be compactly stored in the interior tray volume 112 with trays 106 overlapping one another until access is needed to a particular one of the trays 106 to perform fiber management thereon, at which point one or more of the other trays 106 is pivoted up to provide that access.

The assembly 100 extends from a left side 114 to a right side 116 along a first axis 118. The assembly 100 extends from a front end 120 to a back end 122 along a second axis 124. The assembly 100 extends from a top 126 to a bottom 128 along a third axis 130. The axes 118, 124 and 130 are mutually perpendicular to one another.

Terms such as top, bottom, up, down, upward, downward, front, back, left, right, and the like are used for ease of description only in relating relative positions of features shown in the drawings. These terms are not intended to, and do not, limit how the devices or components of the present disclosure are, or may be, used in practice.

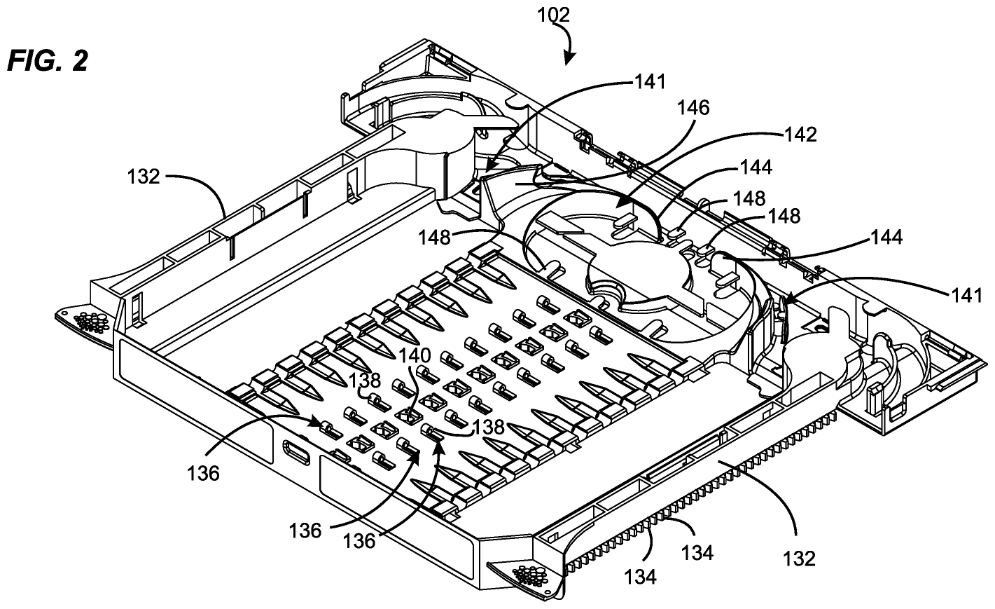

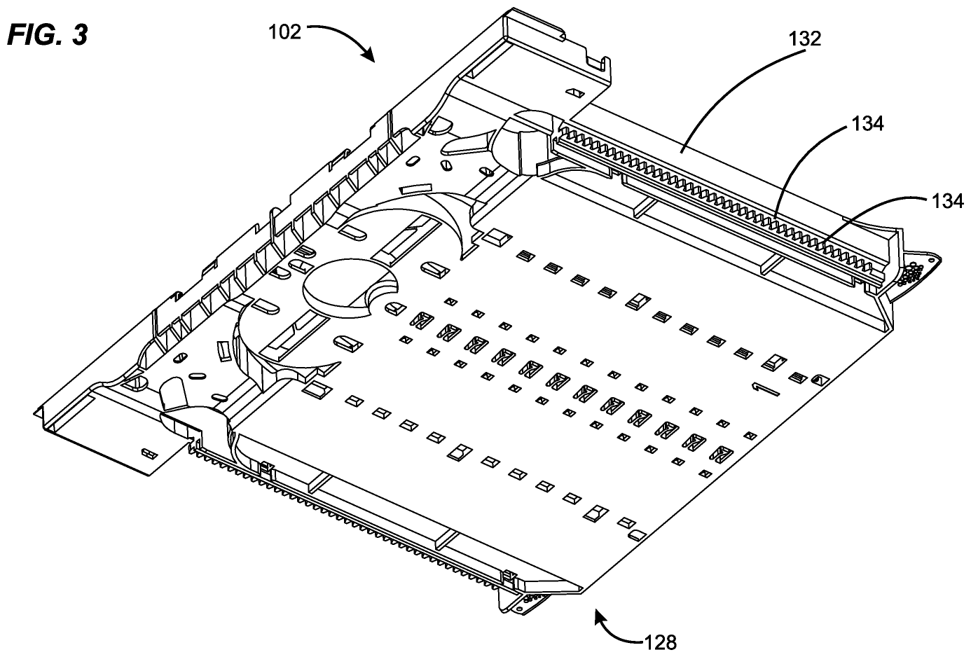

Referring to FIGS. 1-3, the distribution tray 102 includes tracks 132 that include ratchet teeth 134. The tracks 132 are configured to slidingly engage with complementary structures of a rack, such as a rack in a telecommunications distribution center, for selectively accessing the distribution tray 102 (from, e.g., among other distribution trays slidably mounted to the same rack) by sliding it out of the rack, or storing the distribution tray by sliding it back into the rack. For example, the tray 102 can be slid in and out of a rack parallel to the axis 124.

The tray 106 includes an arrangement of tray couplers 136. Each tray coupler 136 includes one or more pin receivers 138 and a latch 140. Each coupler 136 is configured to pivotally mount a fiber management tray 106. For example, the pin receivers 138 are configured to pivotally receive pins of a fiber management tray 106, while the latch 140 is configured to engage the tray 106 to prevent removal of the pins from the receivers 138 without first activating (e.g., flexing) the corresponding latch 140 to release the tray 106.

Optical fibers are routed from off the distribution tray (e.g., from another region of the rack) via the passages 108, 110. Additionally, optical fibers can be routed via internal passages 141 directly to a desired tray 106, alternatively to a fiber routing region 142 of the distribution tray 102, which can redirect fibers from one side of the distribution tray 102 to the other. That is, the fiber routing region 142 can redirect a fiber so that it enters at the side of the fiber management tray 106 that is opposite the side of the tray 102 where the fiber entered the tray 102. The routing region 142 includes curved walls 144 and 146, and retaining lips 148 to guide optical fibers in e.g., figure-8 routing configurations or partial figure-8 routing configurations in order to redirect the fibers. A splice of the optical fibers can be supported and/or another component that manages the fibers, such as a splitter module, or an adapter for optically connecting connectorized optical fibers, or so forth, can be supported on the tray 106.

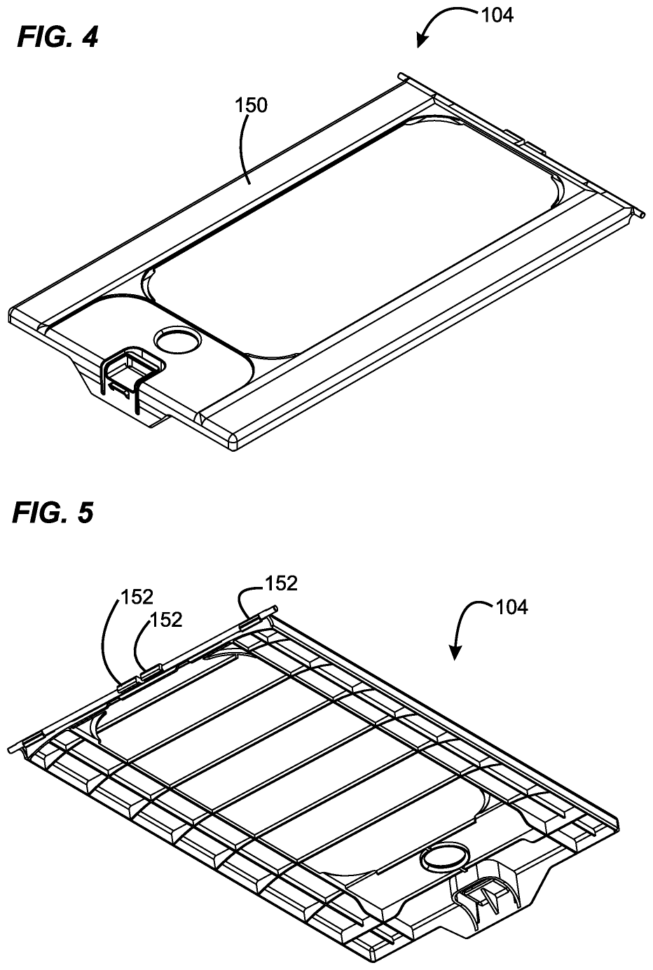

Referring to FIGS. 1-5, the cover 104 is configured to selectively cover the fiber management trays 106 when the fiber management trays 106 are positioned in the interior 112 of the distribution tray 102. The cover 104 includes a cover body 150 that includes coupling features 152 configured to pivotally interface with coupling features 154 of the distribution tray 102. For example, the coupling features 152 can include projections defining recesses and the coupling features 154 can include rods, and the recesses can pivotally receive the rods.

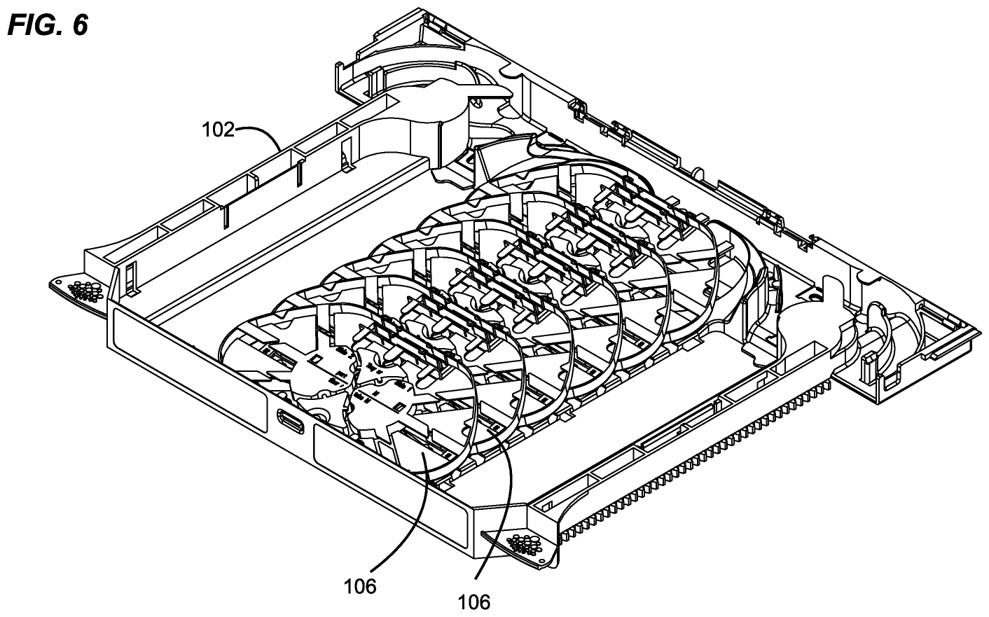

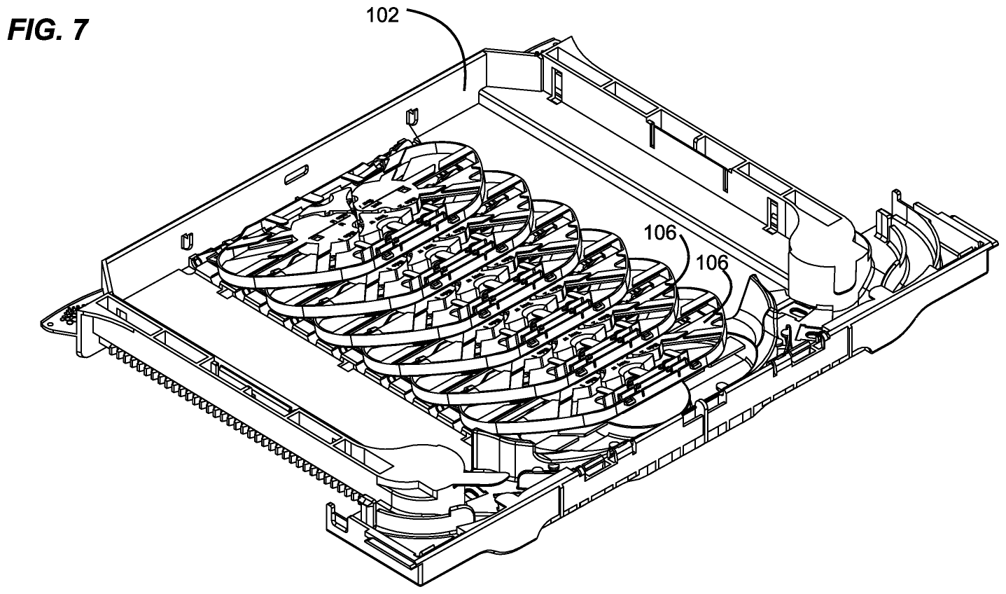

Referring to FIGS. 1-7, the distribution tray 102 is configured to support up to six of the fiber management trays 106 entirely within the volume 112 (e.g., without any portion of any tray 106 extending outside the volume 112), with the trays mounted to every other one of the coupling arrangements 136. In alternative configurations, if the fiber management trays are configured differently (e.g., with different dimensions than the trays 106), more or fewer of the coupling arrangements 136 can be occupied; that is, the distribution tray 102 is able to accommodate more or fewer of the fiber management trays 106 depending on configurations of the fiber management trays.

The fiber management trays 106 are configured to manage rollable fiber ribbons. Rollable fiber ribbons have different management considerations associated with them as compared with individual fibers. This is due to the mechanical structure of rollable fiber ribbons. For example, rollable fiber ribbons are bundled fibers, and so the bundle naturally has a larger transverse thickness than an individual fiber. Thus, for example, a tray having an interior volume deep enough to accommodate an individual fiber may not be deep enough to accommodate a rollable fiber ribbon. In addition, there is a particular need to minimize twisting and points of torsion in a rollable ribbon fiber. Such twists and torsion points can detrimentally result in optical signal loss. Rollable fiber ribbons can be particularly susceptible to signal loss from twisting or torsion due to the spaced apart and/or staggered nature of the bonding locations between the individual fibers, which allows the ribbon to “roll”. Thus, there can be advantages to a fiber management tray that minimizes the points of bending or torsion of rollable fiber ribbons. As will be described in more detail below, structural features and dimensions of the fiber management trays 106 are advantageously configured to accommodate rollable fiber ribbons, while maximizing the number of the trays 106 that can be pivotally mounted to a distribution tray 102 of a given size.

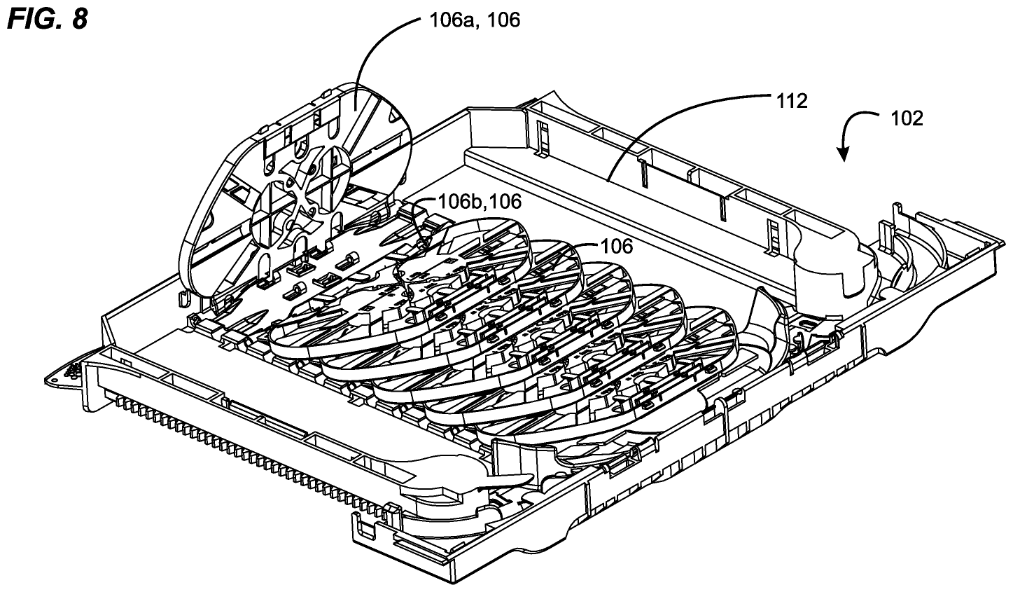

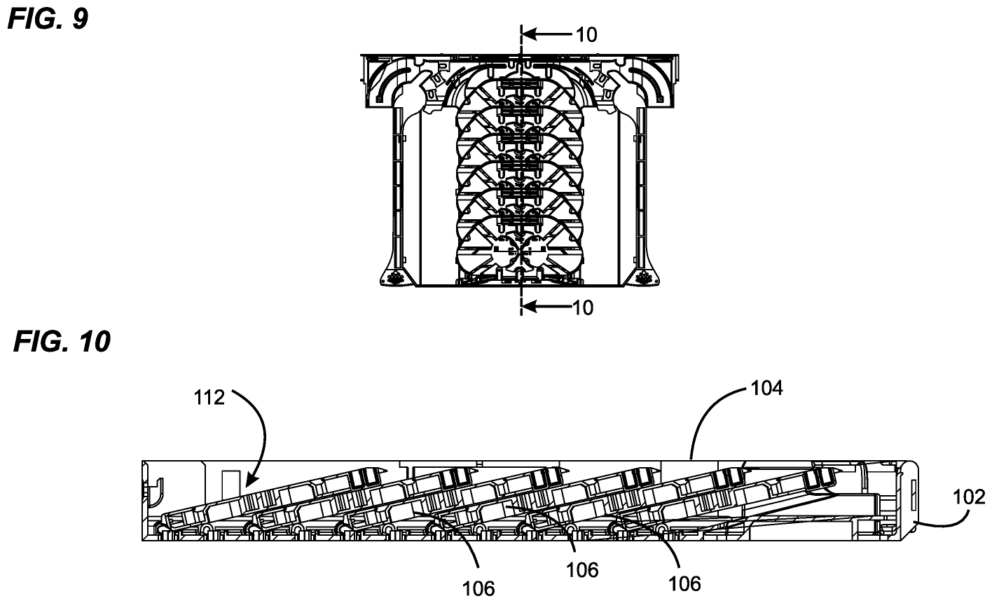

Referring to FIG. 8, one of the fiber management trays 106 (the tray 106a) supported by the distribution tray 102 is pivoted up. The pivoting interface between the tray 106a and the tray 102 is configured to hold the tray 106a in the pivoted up position unless sufficient force is applied to push the tray 106 back to the pivoted down position. In the pivoted up position, access to the tray 106 (the tray 106b) adjacent the tray 106a that is pivoted up can be accessed for fiber splices or other fiber management needs. Likewise, the other trays 106 can be pivoted up to provide access to another tray 106.

Referring to FIG. 10, the trays 106 are configured (e.g., sized and shaped) such that up to at least six of the trays 106 can be pivotally mounted to the distribution tray 102 in the pivoted down configuration and stored in the interior tray volume 112 under the cover 104.

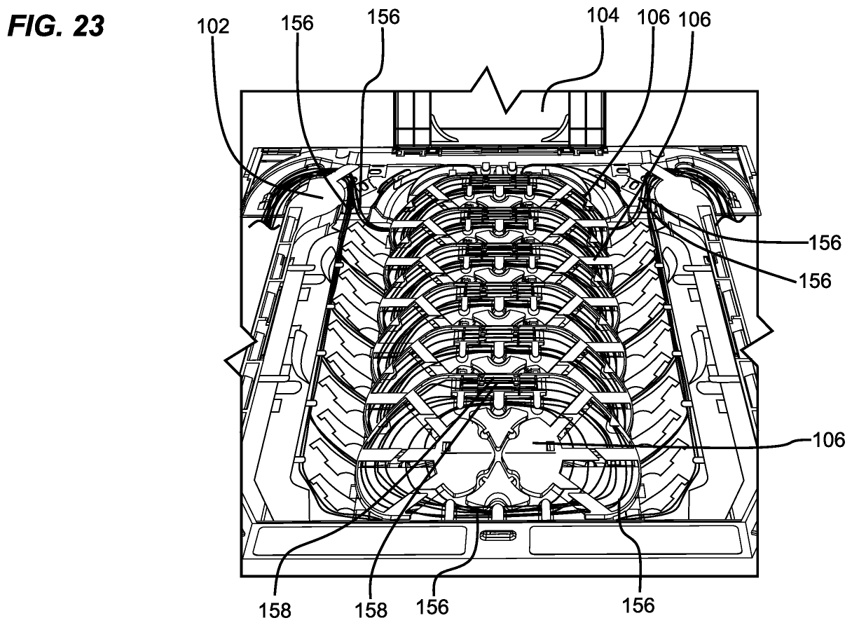

Referring to FIG. 23, the cover 104 is in the open position, showing six of the fiber management trays 106 in the pivoted down configuration pivotally supported in the interior volume 112 of the distribution tray 102. Each of the trays 106 includes rollable ribbon fibers 156 routed onto the trays 106 from the tray 102. Rollable ribbons 156 are spliced to each other at splices protected by splice protection bodies (or splice bodies) 158 that are supported in splice holders defined by the trays 106.

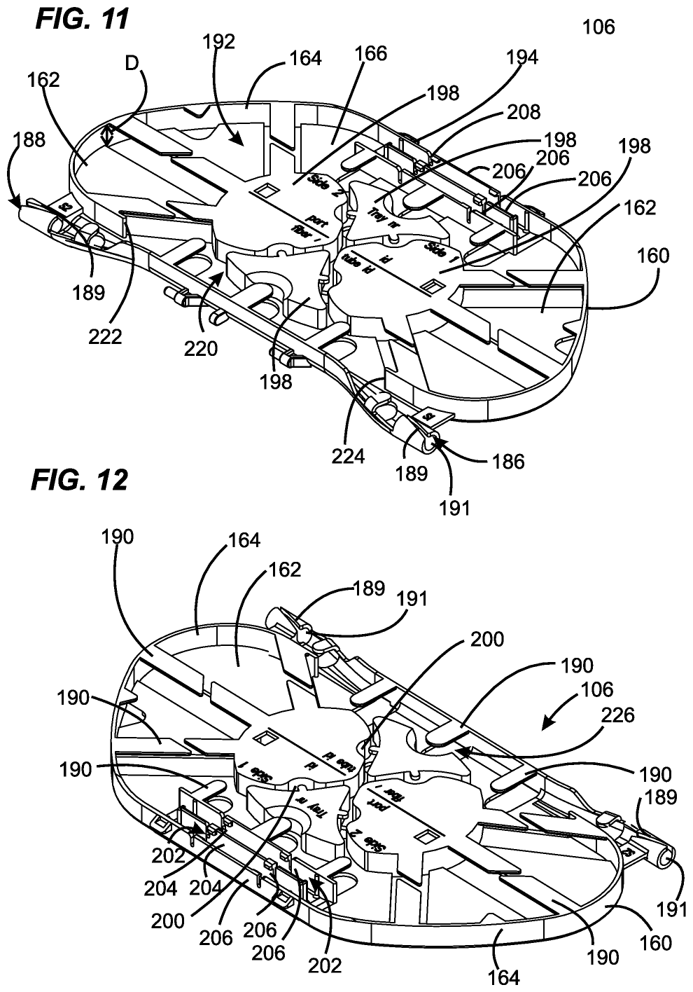

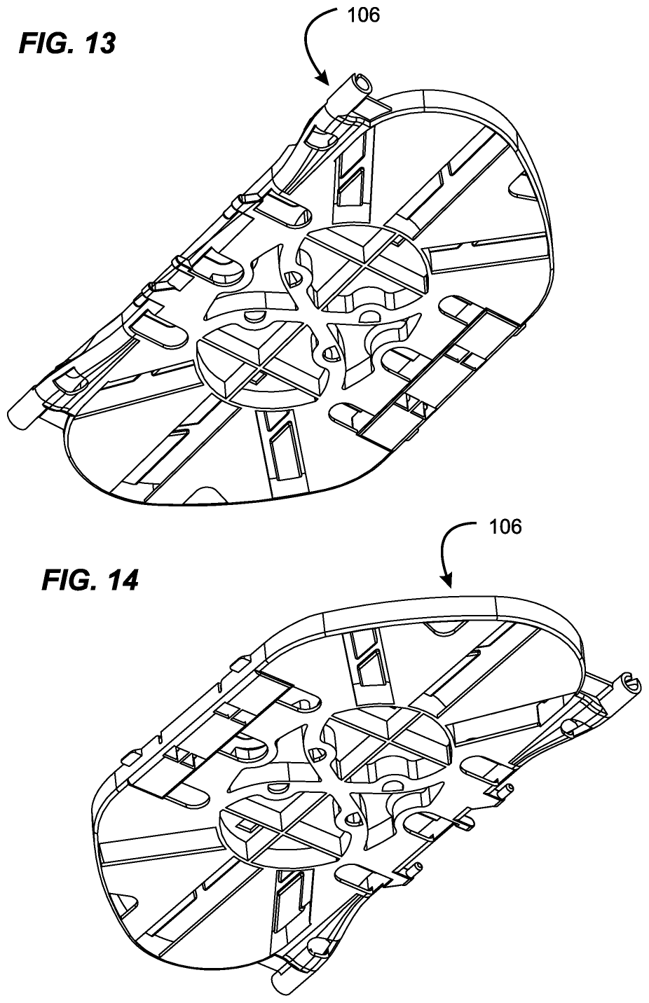

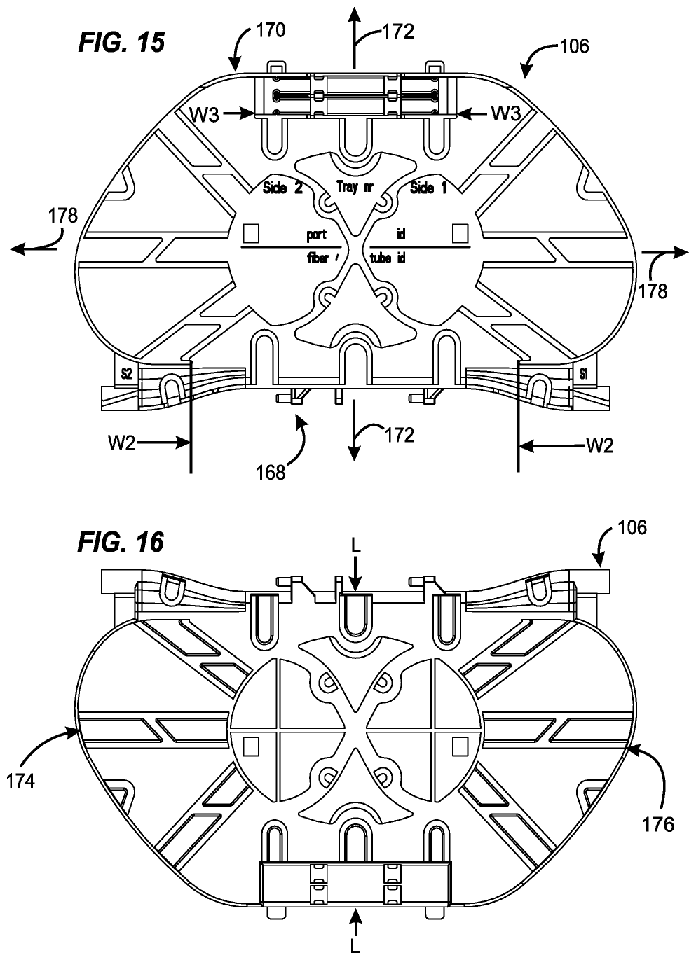

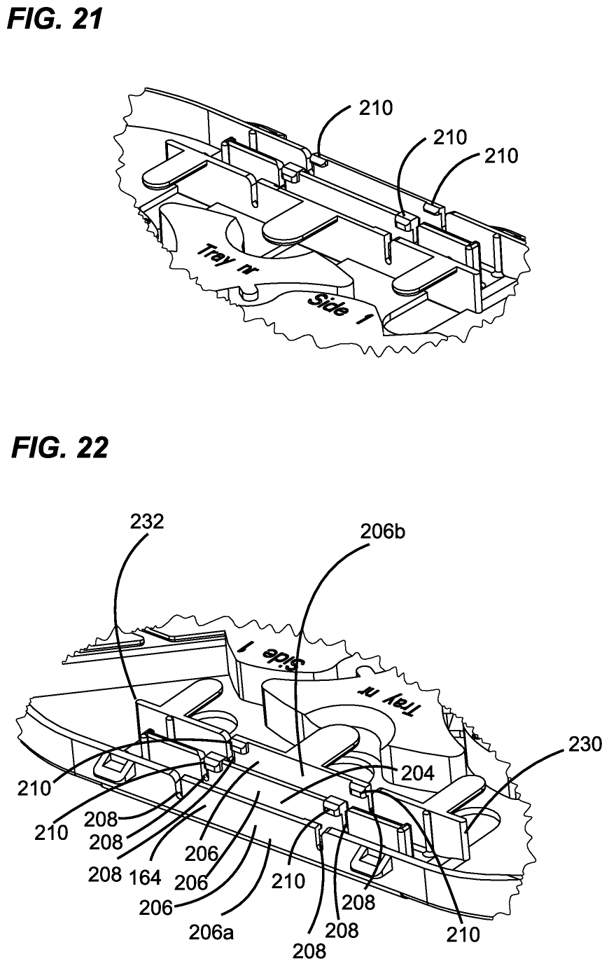

Referring to FIGS. 11-22, the fiber management tray 106 can be constructed of, e.g., a molded polymer, and/or metal. In some examples, all of the features of the fiber management tray 106 can advantageously be of uniform construction. For example, all of the features can be constructed in a seamless fashion as a single, molded part.

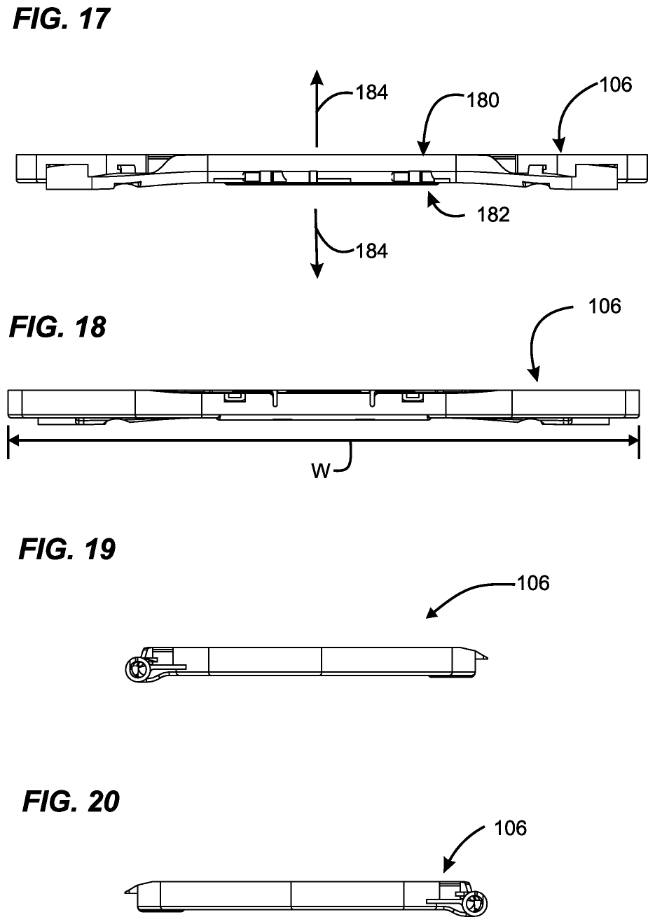

The tray 106 includes a tray body 160 that defines a major fiber management surface 162 (or surfaces) and an outer wall 164 projecting away from the surface 162 parallel to the axis 184 (FIG. 17). The surface 162 and the wall 164 define an interior 166 (or interior volume) of the tray 106.

The tray 106 extends from a back end 168 to a front 170 along an axis 172, from a left side 174 to a right side 176 along a second axis 178, and from a top 180 to a bottom 182 along a third axis 184. The axes 172, 178 and 184 are mutually perpendicular.

The tray 106 includes fiber entryways 186 and 188 at opposite sides of the back of the tray 106. The fiber entryways 186 and 188 provide access for optical fibers (such as rollable fiber ribbons) from exterior to the tray (e.g., from another area of the distribution tray 102) to the interior 166 of the tray. Once in the interior 166 of the tray 106, the rollable fiber ribbons can be guided in the interior 166 between the surface 162 and fiber retention lips 190 projecting parallel to the surface 162 from the outer wall 164 toward a fiber routing region 192 of the tray 106 and/or to a fiber management region 194 of the tray 106. In some examples, as shown, the fiber management region 194 is positioned closer to the front end of the tray 106 than the fiber routing region 190.

The fiber entryways 186 and 188 are defined by a substantially cylindrical surface 191 having an angled and/or curved slit 189 therein. The angled and/or curved slit 189 is configured to permit lateral insertion (rather than axial insertion) of a rollable fiber ribbon into the entryway 186, 188 through the slit 189, while the angle and/or curvature of the slit 189 inhibits unwanted exiting of the rollable fiber ribbons through the slit 189.

The fiber routing region 192 includes routing structures 198 that define pathways 200 for routing optical fibers in a figure-8 or a partial figure-8 configuration so that, for example, a fiber entering the tray 106 from the left side of the tray can be routed to the right side of the fiber management region 194, and vice versa.

The fiber management region 194 is configured to support one or more fiber management components, such as splice bodies that protect splices between fibers of rollable fiber ribbons. In this example, the fiber management region 194 includes splice body holders (or splice holders) 202 integrally formed with the tray 106. Because they are integrally formed, the number of parts needed to assemble the tray 106 can be reduced, for example. The splice body holders include receivers 204 with flexibly resilient latch arms (or latch walls) 206 having latches 210 such that the latch arms 206 can latch splice bodies positioned in the receivers 204. The outer wall 164 defines one of the latch arms 206. Notches 208 are provided in the outer wall 164 which, in part, define the latch arm 206 and which facilitate resilient flexion of the latch arm 206a defined by the outer wall 164 when a splice body is inserted into the corresponding receiver 204. The latch arms 206 include latches 210 that can resiliently snap over splice bodies by resilient action of the corresponding latch arms 206 to hold splice bodies in the corresponding receivers 204.

Advantageously, each receiver 204 is configured to hold a mass-splice between the fibers of two 12-fiber rollable ribbons. Thus, the tray 106 is configured for managing up to at least two pairs of spliced together 12-fiber rollable ribbons.

Along the axis 172, the tray 106 has a maximum length L. In some examples, the length L can refer to the maximum length of the surface 162 along the axis 172 (e.g., the maximum length of the interior volume 166). Along and/or parallel to the axis 178, the tray 106 has a maximum width W. In some examples, the width W can refer to the maximum width of the surface 162 along and/or parallel to the axis 178 (e.g., the maximum width of the interior volume 166). The outer wall 164 has sufficient height to define a maximum depth D of the tray interior 166 parallel to the axis 184, the depth D extending from a top of the wall 164 to the surface 162 parallel to the axis 184. The depth D can refer to the maximum depth of the interior volume 166.

Advantageously, the dimensions L, W and/or D can be configured to maximize fiber management and/or fiber organization between and among different trays 106 supported by the distribution tray 102, particularly for management and organization of rollable fiber ribbons, such as 12-fiber rollable ribbons. For instance, by routing fibers on different trays 106, the trays can serve as organizing components demarcating where particular rollable fiber ribbons are managed, allowing a technician to select particular rollable ribbon fibers to work on based on the tray. In addition, the dimension L, W and/or D are configured so that the tray interior 166 has sufficient depth to accommodate rollable fiber ribbons, while also having sufficient length and width to provide sufficiently gentle bending guidance of rollable fiber ribbons within the interior 166. Thus, the dimensions L, W and D are configured to optimize one or more of the foregoing aspects for a rollable fiber ribbon application of the distribution tray 102. The dimensions L, W and/or D can be configured to maximize the number of trays that can accommodate rollable fiber ribbons and that can be pivotally supported by the distribution tray 102 under the cover 104. For instance, if the length L is increased or the depth D is increased, then at least up to six of the trays 106 may not fit under the cover 104, whereas, if the depth D is decreased, then the tray may not be able to accommodate rollable fiber ribbons.

In some examples, the depth D is at least about 3.0 millimeters, or at least about 3.5 millimeters, or at least about 4.0 millimeters, or at least about 4.5 millimeters, or at least 4.7 millimeters, and not more than about 7.0 mm, or not more than about 6.5 mm, or not more than about 6.0 millimeters, or not more than about 5.5 millimeters, or not more than about 5.0 millimeters. In some examples, the depth D is about 4.75 millimeters across the entirety of the interior 166.

In some examples, to optimize the dimensions of the tray 106 as described, the length L is not more than about 86.0 millimeters, or not more than about 85.0 millimeters, or not more than about 84.0 millimeters, or not more than about 83.0 millimeters, or not more than about 82.0 millimeters, or not more than about 81.0 millimeters, or not more than about 80.0 millimeters, or not more than about 79.0 millimeters, and at least 50.0 millimeters, or at least 70.0 millimeters, or at least 75.0 millimeters, or at least 78.0 millimeters. In some examples, the length L is between about 79.0 millimeters and about 80.0 millimeters. In some examples, the length L is about 79.85 millimeters.

In some examples, to optimize the dimensions of the tray 106 as described, a ratio of D/L is at least 0.040, or at least 0.050, or at least 0.055, or at least 0.056, or at least 0.057, or at least 0.058, or at least 0.059, or at least 0.060. In some examples, the ratio D/L is between about 0.059 and about 0.060.

The outer wall 164 defines a continuous gap 220 extending from one end 222 of the outer wall 164 to another end 224 of the outer wall 166. The gap 220 is positioned adjacent the entryways 186 and 188. The gap 220 is sized (e.g., large enough) to minimize the need for fiber cross-overs in the region 226 as rollable fiber ribbons enter the interior 166 through the opposing entryways 186 and 188. Such points of cross-over can be particularly detrimental for rollable fiber ribbons given the construction of the fiber to fiber bonding locations of a rollable fiber ribbon described above, and the detrimental tendency for pinching or tangling as a result. Thus, for example, the gap 220 can have a width W2 parallel to the axis 178 that is at least 80 millimeters, or at least 90 millimeters, or at least 100 millimeters, or at least 110 millimeters, or at least 120 millimeters, or at least 130 millimeters, or at least 140 millimeters. Similarly, in some examples, a ratio of the width W2 to the width W is at least 0.3 or at least 0.4, or at least 0.5, or at least 0.6, or at least 0.7, or least 0.8, or least 0.9.

The latch arm 206c is minimized in size parallel to the axis 178 to maximize room for routing rollable fiber ribbons to the region 194. This feature is also particularly suited for managing rollable fiber ribbons rather than loose fibers, for instance. In particular, the latch arm 206c does not include any curved extension portions extending beyond its left and right ends 230 and 232. In addition, the width W3 of the latch arm 206c parallel to the axis 178, is relatively short, such that a ratio of W3/W is less than 0.7, or less than 0.6, or less than 0.5, or less than 0.4, or less than 0.3.

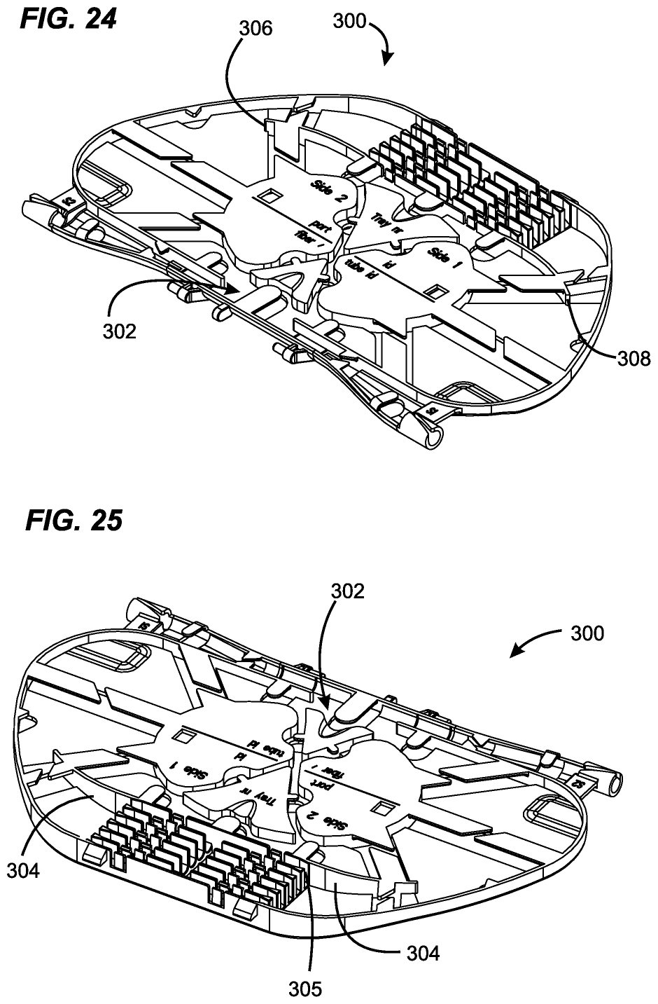

Referring to FIGS. 24-25, the fiber management tray 300 is configured to be pivotally supported by the distribution tray 102. However, the tray 300 is not suitable for managing rollable fiber ribbons (such as 12-fiber rollable ribbons). That is, there are several structural differences between the tray 300 and the tray 106. For example, the corresponding depth of the interior of the tray 300 is significantly less than that of the tray 106. The corresponding length of the tray 300 is significantly more than that of the tray 106. The corresponding ratio of the depth to length of the tray 300 is significantly less than that (D/L) of the tray 106. In addition, the gap 302 in the outer wall of the tray 300 is significantly shorter (and the ratio of the size of that gap to the width of the tray 300 is significantly smaller) than the corresponding features of the tray 106 described above. In addition, the wall 305 of the tray 300, unlike the corresponding wall 206c of the tray 106, includes curved extensions 304. In addition, a ratio of a length of the wall 305 between its ends 306 and 308 to the width of the tray 300 is significantly larger than the corresponding ratio of the tray 106 as described above.

Having described the preferred aspects and embodiments of the present disclosure, modifications and equivalents of the disclosed concepts may readily occur to one skilled in the art. However, it is intended that such modifications and equivalents be included within the scope of the claims which are appended hereto.

What is claimed is:

1. A fiber management tray for managing rollable fiber ribbons, comprising:
a tray body extending from a front end of the tray to a back end of the tray along a first axis, the tray extending form a left end of the tray to a right end of the tray along a second axis, the tray extending from a top end of the tray to a bottom end of the tray along a third axis, the first axis, the second axis and the third axis being mutually perpendicular, the tray body including:
couplers at the back end of the tray for pivotally coupling the fiber management tray to a slidable distribution tray; and
a tray interior volume defined by:
a fiber management surface; and
an outer wall projecting from the fiber management surface parallel to the third axis to define a depth of the interior, the depth extending parallel to the third axis from a top end of the wall to the surface,
wherein a ratio of the depth to a maximum length of the surface parallel to the first axis is at least 0.050.

2. The fiber management tray of claim 1, wherein the ratio is at least 0.055.

3. The fiber management tray of claim 1, wherein the ratio is at least 0.058.

4. The fiber management tray of claim 1, wherein the ratio is between about 0.059 and about 0.060.

5. The fiber management tray of any of claims 1-4,
wherein the tray body defines opposing entryways by which rollable fiber ribbons can enter the tray interior volume;
wherein the outer wall defines a gap in the outer wall adjacent the entryways and extending continuously along a width of the gap from one end of the outer wall to another end of the outer wall parallel to the second axis; and
wherein a second ratio of the gap width to a maximum width of the surface parallel to the second axis is at least 0.3.

6. The fiber management tray of claim 5, wherein the second ratio is at least 0.4.

7. The fiber management tray of claim 5, wherein the second ratio is at least 0.5.

8. The fiber management tray of claim 5, wherein the second ratio is at least 0.6.

9. The fiber management tray of claim 5, wherein the second ratio is at least 0.7.

10. The fiber management tray of claim 5, wherein the second ratio is at least 0.8.

11. The fiber management tray of any of claims 1-10,
wherein the tray body defines within the interior volume a fiber routing region and a fiber management region;
wherein the fiber management region includes other walls in addition to the outer wall that define receivers for receiving splice bodies of splices between rollable fiber ribbon fibers; and
wherein a third ratio of a maximum dimension of each of the outer walls to a maximum width of the surface parallel to the second axis is less than 0.7.

12. The fiber management tray of claim 11, wherein the third ratio is less than 0.5.

13. The fiber management tray of claim 11, wherein the third ratio is less than 0.3.

14. The fiber management tray of any of claims 11-13, wherein none of the outer walls includes a curved extension.

15. The fiber management tray of any of claims 11-14, wherein the fiber management region includes exactly two receivers for receiving splice bodies of splices between fibers of two pairs of rollable fiber ribbons.

16. The fiber management tray of any of claims 1-15, further comprising a rollable fiber ribbon routed in the interior volume on the surface.

17. The fiber management tray of claim 16, wherein the rollable fiber ribbon includes 12 optical fibers.

18. A fiber distribution tray, comprising:
at least six of the fiber management trays of any of claims 1-16 pivotally mounted to a body of the distribution tray and positioned entirely within an interior volume defined by the body of the fiber distribution tray.

19. The fiber distribution tray of claim 18, wherein the distribution tray is configured to slidingly mount to a rack between storage and access positions.

20. The fiber distribution tray of any of claims 18-19, further comprising a cover pivotally connected to the body of the distribution tray for selectively covering the fiber management trays.

21. The fiber distribution tray of any of claims 18-20, further comprising rollable fiber ribbons routed through passageways defined by the body of the fiber distribution tray and into the interior volume of at least one of the fiber management trays, wherein splices between fibers of the rollable fiber ribbons are supported in the interior volume of the at least one of the fiber management trays.

22. The fiber distribution tray of claim 21, wherein each rollable fiber ribbon includes 12 optical fibers.

23. The fiber distribution tray of claim 18, wherein some of the fiber management trays overlap others of the fiber management trays in the interior volume of the fiber distribution tray.

24. A fiber management tray for managing rollable fiber ribbons, comprising:
a tray body extending from a front end of the tray to a back end of the tray along a first axis, the tray extending form a left end of the tray to a right end of the tray along a second axis, the tray extending from a top end of the tray to a bottom end of the tray along a third axis, the first axis, the second axis and the third axis being mutually perpendicular, the tray body including:
couplers at the back end of the tray for pivotally coupling the fiber management tray to a slidable distribution tray; and
a tray interior volume defined by:
a fiber management surface; and
an outer wall projecting from the fiber management surface;
wherein the tray body defines opposing entryways by which rollable fiber ribbons can enter the tray interior volume;
wherein the outer wall defines a gap in the outer wall adjacent the entryways and extending continuously along a width of the gap from one end of the outer wall to another end of the outer wall parallel to the second axis; and
wherein a ratio of the gap width to a maximum width of the surface parallel to the second axis is at least 0.3.

25. The fiber management tray of claim 24, wherein the ratio is at least 0.6.

26. The fiber management tray of claim 24, wherein the ratio is at least 0.7.

27. The fiber management tray of claim 24, wherein the ratio is at least 0.8.

28. A fiber management tray for managing rollable fiber ribbons, comprising:
a tray body extending from a front end of the tray to a back end of the tray along a first axis, the tray extending form a left end of the tray to a right end of the tray along a second axis, the tray extending from a top end of the tray to a bottom end of the tray along a third axis, the first axis, the second axis and the third axis being mutually perpendicular, the tray body including:
couplers at the back end of the tray for pivotally coupling the fiber management tray to a slidable distribution tray; and
a tray interior volume defined by:
a fiber management surface; and
an outer wall projecting from the fiber management surface;
wherein the tray body defines within the tray interior volume a fiber routing region and a fiber management region;
wherein the fiber management region includes other walls in addition to the outer wall that define receivers for receiving splice bodies of splices between rollable fiber fibers; and
wherein a ratio of a maximum dimension of each of the outer walls to a maximum width of the surface parallel to the second axis is less than 0.7.

29. The fiber management tray of claim 28, wherein the ratio is less than 0.5.

30. The fiber management tray of claim 28, wherein the ratio is less than 0.3.
